(19) United States
(12) Patent Application Publication
(10) Pub. No.: US 2025/0022471 A1
(43) Pub. Date: Jan. 16, 2025

(54) CONFERENCE CONTENT DISPLAY METHOD, CONFERENCE SYSTEM AND CONFERENCE DEVICE

(71) Applicant: BOE Technology Group Co., Ltd., Beijing (CN)

(72) Inventor: Shaoxun SU, Beijing (CN)

(21) Appl. No.: 18/711,020

(22) PCT Filed: Nov. 19, 2021
(86) PCT No.: PCT/CN2021/131943

§ 371 Date: May 16, 2024

(51) Int. Cl. G10L 17/22; G06F 40/58; G10L 17/02; H04L 65/403

(52) U.S. Cl. CPC G10L 17/22; G06F 40/58; G10L 17/02; H04L 65/403

(57) ABSTRACT

A conference content display method, a conference system and a conference device. The method includes: determining speech text corresponding to speech information, which is collected by a terminal of a conference participant; and displaying conference content related to the speech text.

### CROSS-REFERENCE TO RELATED APPLICATIONS

The disclosure is a National Stage of International Application No. PCT/CN2021/131943, filed on Nov. 19, 2021, the content of which is hereby incorporated by reference in its entirety.

### TECHNICAL FIELD

The present disclosure relates to the technical field of smart conferences, and in particular to a method for displaying a conference content, a conference system and a conference device.

### BACKGROUND

In recent years, the sales of conference whiteboards have increased year by year, and the commercial flat panel market still maintains a high growth trend. The normalization of telecommuting has created a demand for conference whiteboards, which is also a manifestation of the digital transformation of office meetings. “Industrial User Survey Data Shows User 2020 China Smart Device Office Experience Trend Report” expects artificial intelligence (AI) technology to have more abundant applications in the office field, 89% of users expect AI to be applied to analysis and optimization work, such as AI voice recognition; 74% of users expect AI to complete more repetitive tasks, such as automatically forming conference records; and most users hope that the AI technology can reduce the burden of manual data integration.

The conference system of the conference machine in the current market mainly relies on the microphone of the conference machine. The microphone of the conference machine is far-field pickup, so there are strict requirements on the speaking volume of the participants and the noise of the conference room, and the result of voice recognition is easily affected by the external noise interference. If there are multiple participants speaking at the same time, because the content of each person's speech cannot be separated, resulting in voice recognition errors, not only are the voice texts of the participants unable to be displayed on the display in real time, but also conference records cannot be generated based on the results of voice recognition.

### SUMMARY

The disclosure provides a method for displaying a conference content, a conference system and a conference device, which are used to solve the problem that far-field sound pickup cannot separate the content of simultaneous speeches of multiple people, and at the same time avoid increasing the hardware cost of microphones for participants.

In the first aspect, a method for displaying the conference content provided by an embodiment of the present disclosure includes:
determining the voice text corresponding to the voice information collected by the terminal of the participating user; and
displaying the conference content related to the voice text.

As an optional implementation manner, the determining of the voice text corresponding to the voice information collected by the terminal of the participating user, includes:

receiving the voice information collected by the terminal, performing voice recognition on the voice information, and determining the voice text corresponding to the voice information.

As an optional implementation manner, the determining of the voice text corresponding to the voice information collected by the terminal of the participating user, includes:

receiving a voice text, and determining the received voice text as the voice text corresponding to the voice information.

As an optional implementation manner, the receiving voice text includes:
receiving the voice text sent by the server; or,
receiving the voice text sent by the terminal.

As an optional implementation manner, an operation of performing voice recognition on the voice information and determining the voice text corresponding to the voice information includes:

performing voice recognition on the voice information through the connected edge end device, and determining the voice text corresponding to the voice information.

As an optional implementation manner, the voice text sent by the server is obtained by: the server receiving voice information sent by the terminal and performing voice recognition on the voice information; or,

the voice text sent by the server is obtained by: the server receiving the voice information of the terminal forwarded by the conference device and performing voice recognition on the voice information.

As an optional implementation manner, the voice text sent by the terminal is obtained by: the terminal sending voice information to a server for voice recognition and receiving the voice text sent by the server; or,

the voice text sent by the terminal is obtained by: the terminal performing voice recognition on the voice information.

As an optional implementation manner, the voice text is determined according to the voice information whose volume satisfies a condition among the voice information collected by the terminal of the participating user.

As an optional implementation manner, the receiving of the voice information collected by the terminal includes:

establishing a communication connection with the terminal, and receiving the voice information collected by the terminal through streaming transmission.

As an optional implementation manner, the voice text further includes user information, the user information is determined according to the voiceprint feature corresponding to the voice information, and the voiceprint feature is obtained by performing voiceprint recognition on the voice information.

As an optional implementation manner, after determining the voice text corresponding to the voice information collected by the terminal of the participating user, the method further includes:
generating a conference record according to the voice text; or,
generating a conference record according to the voice text and user information corresponding to the voice text.

As an optional implementation manner, after generating a conference record, the method further includes:
identifying key information in the conference record according to a text summarization algorithm, and generating a conference summary according to the identified key information; or,
sending the conference record to the server, so that the server identifies key information in the conference record according to a text summarization algorithm to obtain a conference summary; and receiving the conference summary sent by the server; or,
forwarding the conference record to the server through the terminal, so that the server identifies the key information in the conference record according to the text summarization algorithm to obtain a conference summary; and receiving the conference summary forwarded by the server through the terminal.

As an optional implementation manner, the method further includes:

generating a download link address corresponding to at least one of the conference record or the conference summary.

As an optional implementation manner, after generating the conference record, the method further includes:
obtaining the voice file uploaded locally, and determining the supplementary voice text and the supplementary voiceprint feature corresponding to the uploaded voice information in the voice file;
generating a supplementary conference record according to the supplementary voice text and the supplementary user information corresponding to the supplementary voiceprint features; and
updating the conference record by using the supplementary conference record.

As an optional implementation manner, after determining the voice text corresponding to the voice information collected by the terminal of the participating user, the method further includes:
directly translating the voice text into a translated text corresponding to a preset language type; or,
translating the voice text into a translated text corresponding to a preset language type through the connected edge end device; or,
determining the translated text received from the server as the translated text corresponding to the voice text.

As an optional implementation manner, the displaying of the conference content related to the voice text includes at least one of:
displaying the voice text in real time;
displaying the user name corresponding to the voice text in real time;
displaying a conference record related to the voice text;
displaying a conference summary related to the voice text;
displaying a translated text of a preset language type translated from the voice text in real time;
displaying a download link address corresponding to the conference record related to the voice text; or
displaying a download link address corresponding to the conference summary related to the voice text.

As an optional implementation manner, after displaying the conference content related to the voice text, the method further includes:

in response to the user's second editing instruction for at least one of the conference record or the conference summary, performing a corresponding editing operation on the content corresponding to the second editing instruction; herein the editing operation includes at least one of modification, addition, or deletion.

In the second aspect, a conference system provided by an embodiment of the present disclosure includes a user terminal and a conference device, wherein:
the user terminal is configured to collect voice information; and
the conference device is configured to determine the voice text corresponding to the voice information collected by the user terminal and display the conference content related to the voice text.

As an optional implementation manner, the user terminal is configured to send the collected voice information to the conference device; and the conference device is configured to perform voice recognition on the voice information to obtain a voice text.

As an optional implementation manner, the system further includes a server:
the user terminal is configured to send the collected voice information to the server; the server is configured to perform voice recognition on the voice information to obtain a voice text, and send the voice text to the user terminal; and the user terminal is configured to send the voice text to the conference device; or,
the user terminal is configured to send the collected voice information to the conference device; the conference device is configured to forward the voice information to the server; and the server is configured to perform voice recognition on the voice information to obtain a voice text, and send the voice text to the conference device.

As an optional implementation manner, the user terminal is further configured to:

perform voice recognition on the collected voice information to obtain a voice text, and send the voice text to the conference device.

As an optional implementation manner, the voice text is determined according to voice information whose volume satisfies a condition among the voice information collected by the user terminal.

As an optional implementation manner, the voiceprint feature is determined according to voice information whose volume satisfies a condition among the voice information collected by the user terminal.

As an optional implementation manner, the conference device is configured to perform voice recognition on the voice information through the connected edge end device to obtain the voice text.

As an optional implementation manner, the conference device is configured to establish a communication connection with the user terminal, and receive the voice information collected by the user terminal through streaming transmission.

As an optional implementation manner, the voice text further includes user information, the user information is determined according to the voiceprint feature corresponding to the voice information, and the voiceprint feature is obtained by performing voiceprint recognition on the voice information.

As an optional implementation manner, the conference device is further configured to:
generate a conference record according to the voice text; or,
generate a conference record according to the voice text and the user name corresponding to the voice text.

As an optional implementation manner, the conference device is configured to: identify key information in the conference record according to a text summarization algorithm, and generate a conference summary according to the identified key information; or,
the conference device is configured to send the conference record to the server; and the server is configured to identify key information in the conference record according to a text summarization algorithm to obtain a conference summary, and send the conference summary to the conference device; or,
the conference device is configured to forward the conference record to the server through the terminal; and the server is configured to: identify key information in the conference record according to a text summarization algorithm to obtain a conference summary, and forward the conference summary through the terminal to the conference device.

As an optional implementation manner, the conference device is further configured to:

generate a download link address corresponding to at least one of the conference record or the conference summary.

As an optional implementation manner, the conference device is configured to translate the voice text into a translated text corresponding to a preset language type; or,
the conference device is configured to translate the voice text into the translated text corresponding to the preset language type through the connected edge end device; or,
the server is configured to translate the voice text into a translated text corresponding to a preset language type, and send the translated text to the conference device.

As an optional implementation manner, the conference device is further configured to display the conference content related to the voice text through at least one of:
displaying the voice text in real time;
displaying the user name corresponding to the voice text in real time;
displaying a conference record related to the voice text;
displaying a conference summary related to the voice text;
displaying a translated text of a preset language type translated from the voice text in real time;
displaying a download link address corresponding to the conference record related to the voice text; or
displaying a download link address corresponding to the conference summary related to the voice text.

In a third aspect, a conference device provided by an embodiment of the present disclosure includes a processor and a memory, the memory is configured to store programs executable by the processor, and the processor is configured to read the programs in the memory and perform:
determining the voice text corresponding to the voice information collected by the terminal of the participating user; and
displaying the conference content related to the voice text.

As an optional implementation manner, the processor is specifically configured to execute:

receiving the voice information collected by the terminal, performing voice recognition on the voice information, and determining the voice text corresponding to the voice information.

As an optional implementation manner, the processor is specifically configured to execute:

receiving a voice text, and determining the received voice text as the voice text corresponding to the voice information.

As an optional implementation manner, the processor is specifically configured to execute:
receiving the voice text sent by the server; or,
receiving the voice text sent by the terminal.

As an optional implementation manner, the processor is specifically configured to execute:

performing voice recognition on the voice information through the connected edge end device, and determining the voice text corresponding to the voice information.

As an optional implementation manner, the voice text sent by the server is obtained by: the server receiving the voice information sent by the terminal and performing voice recognition on the voice information; or,

the voice text sent by the server is obtained by: the server receiving the voice information of the terminal forwarded by the conference device and performing voice recognition on the voice information.

As an optional implementation manner, the voice text sent by the terminal is obtained by: the terminal sending voice information to a server for voice recognition and receiving the voice text sent by the server; or,

the voice text sent by the terminal is obtained by: the terminal performing voice recognition on the voice information.

As an optional implementation manner, the voice text is determined according to the voice information whose volume satisfies a condition among the voice information collected by the terminal of the participating user.

As an optional implementation manner, the processor is specifically configured to execute:

establishing a communication connection with the terminal, and receiving the voice information collected by the terminal through streaming transmission.

As an optional implementation manner, the voice text further includes user information, the user information is determined according to the voiceprint feature corresponding to the voice information, and the voiceprint feature is obtained by performing voiceprint recognition on the voice information.

As an optional implementation manner, after determining the voice text corresponding to the voice information collected by the terminal of the participating user, the processor is specifically further configured to execute:
generating a conference record according to the voice text; or,
generating a conference record according to the voice text and user information corresponding to the voice text.

As an optional implementation manner, after generating a conference record, the processor is specifically further configured to execute:
identifying key information in the conference record according to a text summarization algorithm, and generating a conference summary according to the identified key information; or,
sending the conference record to the server, so that the server identifies key information in the conference record according to a text summarization algorithm to obtain a conference summary; and receiving the conference summary sent by the server; or,
forwarding the conference record to the server through the terminal, so that the server identifies the key information in the conference record according to the text summarization algorithm to obtain a conference summary; and receiving the conference summary forwarded by the server through the terminal.

As an optional implementation manner, the processor is specifically further configured to execute:

generating a download link address corresponding to at least one of the conference record or the conference summary.

As an optional implementation manner, after generating the conference record, the processor is specifically further configured to execute:
obtaining the voice file uploaded locally, and determining the supplementary voice text and the supplementary voiceprint feature corresponding to the uploaded voice information in the voice file;
generating a supplementary conference record according to the supplementary voice text and the supplementary user information corresponding to the supplementary voiceprint feature; and
updating the conference record by using the supplementary conference record.

As an optional implementation manner, after determining the voice text corresponding to the voice information collected by the terminal of the participating user, the processor is specifically further configured to execute:
directly translating the voice text into a translated text corresponding to a preset language type; or,
translating the voice text into a translated text corresponding to a preset language type through the connected edge end device; or,
determining a translated text received from the server as the translated text corresponding to the voice text.

As an optional implementation manner, the processor is specifically configured to execute:
displaying the voice text in real time;
displaying the user name corresponding to the voice text in real time;
displaying a conference record related to the voice text;
displaying a conference summary related to the voice text;
displaying a translated text of a preset language type translated from the voice text in real time;
displaying a download link address corresponding to a conference record related to the voice text;
displaying a download link address corresponding to a conference summary related to the voice text.

As an optional implementation manner, after displaying the conference content related to the voice text, the processor is specifically further configured to execute:

in response to the user's second editing instruction for at least one of the conference record or the conference summary, performing a corresponding editing operation on the content corresponding to the second editing instruction; herein the editing operation includes at least one of modification, addition, or deletion.

In a fourth aspect, an embodiment of the present disclosure further provides a computer storage medium, on which computer programs are stored; and when the programs are executed by a processor, the steps of the method described in the above-mentioned first aspect are implemented.

These or other aspects of the present disclosure will be more concise and understandable in the description of the following embodiments.

### BRIEF DESCRIPTION OF FIGURES

in order to more clearly illustrate the technical solutions in the embodiments of the present disclosure, the drawings that need to be used in the description of the embodiments will be briefly introduced below. Obviously, the drawings in the following description are only some embodiments of the present disclosure. Those skilled in the art can also obtain other drawings based on these drawings without any creative effort.

FIG. 1 is an implementation flowchart of displaying a conference content provided by an embodiment of the present disclosure.

FIG. 2 is a schematic diagram of a conference system provided by an embodiment of the present disclosure.

FIG. 3 is an implementation flow chart of a method for recording a conference provided by an embodiment of the present disclosure.

FIG. 4 is a flow chart of a specific conference record provided by an embodiment of the present disclosure.

FIG. 5 is a schematic diagram of a conference device provided by an embodiment of the present disclosure.

FIG. 6 is a schematic diagram of a device for displaying a conference content provided by an embodiment of the present disclosure.

### DETAILED DESCRIPTION

In order to make the purpose, technical solutions and advantages of the present disclosure clearer, the present disclosure will be further described in detail below in conjunction with the accompanying drawings. Apparently, the described embodiments are only some of the embodiments of the present disclosure, not all of them. Based on the embodiments in the present disclosure, all other embodiments obtained by persons of ordinary skill in the art without creative efforts fall within the protection scope of the present disclosure.

The term “and/or” in the embodiments of the present disclosure describes the association relationship of associated objects, indicating that there may be three relationships, for example, A and/or B, which may mean: A exists alone, A and B exist simultaneously, and B exists alone. The character “/” generally indicates that the contextual objects are an “or” relationship.

The application scenarios described in the embodiments of the present disclosure are to illustrate the technical solutions of the embodiments of the present disclosure more clearly, and do not constitute limitations on the technical solutions provided by the embodiments of the present disclosure. It appears that the technical solutions provided by the embodiments of the present disclosure are also applicable to similar technical problems. In the description of the present disclosure, unless otherwise specified, “plurality” means two or more.

In recent years, the sales of conference whiteboards have increased year by year, and the commercial flat panel market still maintains a high growth trend. The normalization of telecommuting has created a demand for conference whiteboards, which is also a manifestation of the digital transformation of office meetings. “Industrial User Survey Data Shows User 2020 China Smart Device Office Experience Trend Report” expects the artificial intelligence (AI) technology to have more abundant applications in the office field, 89% of users expect AI to be applied to analysis and optimization work, such as AI voice recognition; 74% of users expect AI to be able to complete more repetitive tasks, such as automatically forming conference records; and most users hope that the burden of manual data integration can be reduced by using the AI technology. The conference system of the conference machine in the current market mainly relies on the microphone of the conference machine. The microphone of the conference machine is far-field pickup, so there are strict requirements on the speaking volume of the participants and the noise of the conference room, and the result of voice recognition is easily affected by the external noise interference. If there are multiple participants speaking at the same time, because the content of each person's speech cannot be accurately separated, resulting in voice recognition errors, the voice texts of the participants cannot be displayed on the display screen of the conference machine in real time, and it is impossible to realize the real-time screen display function of the voice texts, which eventually leads to the inability to generate conference records based on the results of voice recognition.

Embodiment 1: some embodiments of the present disclosure provide a conference recording method, of which the core idea is to use the respective terminals of the participating users to pick up the terminal sound. Since the terminals have become daily necessities at present, and in the scenario where the participating users speak, the volume obtained based on the terminal sound pickup can usually meet the minimum volume requirement for voice recognition. Therefore, based on the terminal sound pickup, it can not only solve the problem of high requirements of the speech volume and noise for far-field pickup, but also avoid the problem of increasing the hardware cost of the participant's microphone in a case that the number of the participants are relatively greater.

In the conference recording method provided by the embodiments of the present disclosure, the voice information of the corresponding participant is collected through the terminal of the participant, and the collected voice information of the participant is recognized. Since the voice information of the participant is collected through the terminal, the collected voice information belongs to near-field pickup, which can meet the requirements for the volume, noise and the like, and improve the accuracy of voice recognition. It can still realize the real-time screen display function of voice texts of participating users when many people are speaking at the same time, to further generate accurate conference records, and provide a low-cost, more portable and accurate solution of automatically recording the conference.

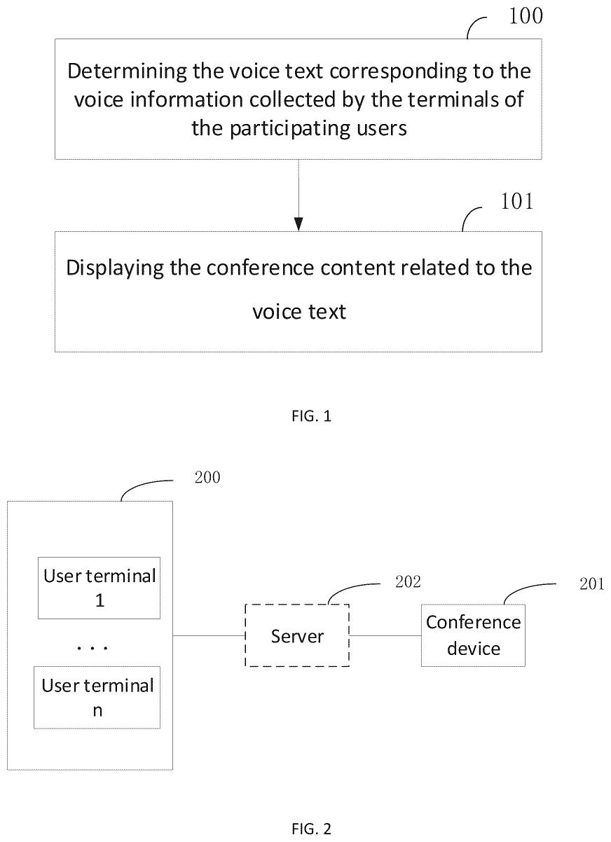

As shown in FIG. 1, a method for displaying a conference content provided by the embodiments of the present disclosure is applied to conference devices, and the conference devices and terminals involved in the embodiments can achieve communicate connection through various wireless methods such as Bluetooth and WIFI. The implementation process of this method includes:
step 100: determining the voice text corresponding to the voice information collected by the terminals of the participating users; and
step 101: displaying the conference content related to the voice text.

In some embodiments, the conference device determines the voice text in any one or more of the following modes.

Mode 1: the conference device itself performs voice recognition to obtain the voice text.

In some embodiments, the voice information collected by the terminal is received, voice recognition is performed on the voice information, and the voice text corresponding to the voice information is determined.

In some embodiments, the conference device can perform voice recognition on the voice information by itself, and determine the voice text corresponding to the voice information; and the conference device can also perform voice recognition on the voice information through the connected edge end device, and determine the voice text corresponding to the voice information. Here, the edge end device includes but is not limited to at least one of an edge development mainboard and an open pluggable specification (OPS), which is not limited too much in the embodiments.

In some embodiments, the conference device can receive the voice text without the need for the conference device itself to perform voice recognition, display the received voice text in real time, and generate a conference record. The specific receiving methods include but are not limited to: receiving the voice text sent by a server; or, receiving the voice text sent by the terminal.

Mode 2: the server performs voice recognition to obtain the voice text, and the server sends the voice text to the conference device.

In some embodiments, after the server determines the voice text, the server sends the voice text to the conference device, and the conference device determines the voice text received from the server as the voice text corresponding to the voice information.

In some embodiments, the server may determine the voice text in any one or more ways as follows:
mode 2a: the server receives the voice information sent by the terminal, and performs voice recognition on the voice information to obtain the voice text; and
mode 2b: the server receives the voice information of the terminal forwarded by the conference device, and performs voice recognition on the voice information to obtain the voice text.

Mode 3: the server performs voice recognition to obtain the voice text, and the terminal sends the voice text to the conference device.

In some embodiments, after the server determines the voice text, the server sends the voice text to the terminal, the terminal sends the received voice text to the conference device, and the conference device determines the voice text received from the terminal as the voice text corresponding to the voice information.

In some embodiments, the terminal may determine the voice text in any one or more of the following modes:
mode 3a: the terminal sends the voice information to the server for voice recognition, the server obtains the voice text after voice recognition and sends the voice text to the terminal, and the terminal receives the voice text sent by the server; and
mode 3b: the terminal forwards the voice information to the server through the conference device for voice recognition, the server obtains the voice text after voice recognition and sends the voice text to the terminal, and the terminal receives the voice text sent by the server.

Mode 4: the terminal performs voice recognition to obtain the voice text, and the terminal sends the voice text to the conference device.

During implementation, after the terminal collects the voice information, the terminal performs voice recognition on the collected voice information, and sends the voice text obtained by the voice recognition to the conference device.

It should be noted that when the current conference device is in use, there is a problem of difficulty in accessing the wireless network. Since enterprises have confidentiality requirements when conducting conferences, they usually strictly control the network access of conference devices, resulting in inconvenience for the conference devices using the cloud server or cloud device to perform multiple functions such as voice recognition, voiceprint recognition, speech translation, and conference summary generation etc. For this, some embodiments of the present disclosure provide a solution of receiving the voice text and generating the conference record through the accessed participating user's terminal, so that the voice text obtained by the terminal's voice recognition or the voice text received by the terminal from the server is sent to the conference device, avoiding the communication connection between the conference device and the server, and ensuring the confidentiality of the conference.

In some embodiments, before obtaining the voice information collected by the terminals of the participating users, a communication connection with the terminal of each participating user can be established first. During implementation, a persistent connection can be established with the terminals of the participating users in order to obtain the voice stream collected by the terminals in real-time. The voice information collected by the terminals of the participating users can be obtained through streaming transmission.

In some embodiments, the ways to establish a communication connection with the terminals include Bluetooth and WIFI, and the way of displaying the conference quick response (QR) code on the conference end and scanning the conference QR code through the terminal to determine the establishment of communication connection with the terminal. In the embodiments, there are no too many limitations on the connection mode between the conference device and the terminal.

In some embodiments, the streaming transmission in the embodiments includes but is not limited to at least one of real-time streaming and progressive streaming. This embodiment can obtain the voice information collected by the terminal in real time, so that after the voice information is recognized, the recognized voice text can be displayed in real time on at least one of the conference end and the terminal, and therefore the participants can see the speech content of the speaker in real time, which can effectively improve the interactive efficiency and interactive experience of the conference.

In some embodiments, the voice recognition can be performed on the input voice information through a trained deep learning model (such as a voice recognition model), and the corresponding voice text can be output. This embodiment does not make too many limitations on how to perform voice recognition, and this embodiment does not make too many limitations on the training samples and training process of the deep learning model.

In order to more accurately separate the voice information of different participants, this embodiment may initially screen the voice information collected by the terminal based on the principle that the farther the distance between the participating user and the terminal is, the smaller the volume of the participating user collected by the terminal is; and then perform voice recognition on the voice information whose volume meets the conditions, so as to extract voice information more accurately and improve the accuracy of voice recognition.

In some embodiments, this embodiment determines the voice text of the voice information collected by the terminal in the following manner.

Firstly, the voice information collected by the terminals is screened to obtain voice information whose volume satisfies the condition. During implementation, the voice information with the largest volume can be screened out, or the voice information with the largest volume can be screened out from voice information with a volume greater than a volume threshold. This embodiment does not make too many limitations on the implementation manner of how to screen out the volume satisfying the condition. In a specific situation, the corresponding setting of the satisfying condition of the volume may be performed according to the requirement for acquiring voice, and this embodiment does not make too many limitations on this.

Secondly, voice recognition is performed on the voice information whose volume satisfies the condition, and the voice text of the voice information is determined. During implementation, there are usually multiple users participating the conference, so there are multiple corresponding terminals. For any terminal, the voice information of the speaker may be collected, so the voice information collected by different terminals can be screened according to the volume, to recognize the screened voice information. It should be noted that when multiple speakers are speaking, the distance between each speaker and its own terminal is usually the shortest, so the voice information of the maximum volume collected by each speaker's terminal is usually the voice information of the speaker. Then the voice information of the corresponding speaker can be extracted from different terminals through the volume, so as to separate the voice information of multiple speakers speaking at the same time, and screen out the voice information of each speaker, thereby improving the accuracy of voice recognition, and further improving the accuracy of conference records.

In some embodiments, the voice text is determined according to the voice information whose volume satisfies a condition among the voice information collected by the terminals of the participating users. During implementation, the voice information may be screened and then recognized through any one or more of the following cases.

Case 1: the conference device screens voice information.

The conferencing device receives the voice information collected by the terminals, screens out voice information whose volume meets the condition from the collected voice information, performs voice recognition on the screened voice information, and determines the voice text corresponding to the voice information.

Case 2: the server screens the voice information.

After receiving the collected voice information, the server screens out voice information whose volume meets the condition from the collected voice information, performs voice recognition on the screened voice information, and determines the voice text corresponding to the voice information.

Case 3: the terminal screens the voice information.

After the terminal collects the voice information, the terminal screens out the voice information whose volume meets the condition from the collected voice information, and sends the screened voice information to the server for voice recognition, or forwards the screened voice information to the server through the conference device for voice recognition.

In some embodiments, the voice text further includes user information. The user information is determined according to the voiceprint features corresponding to the voice information. The voiceprint features are obtained by performing voiceprint recognition on the voice information. In this embodiment, while performing voice recognition on the voice information collected by the terminal to determine the voice text of the voice information, voiceprint recognition may also be performed on the voice information collected by the terminal to determine the user information corresponding to the voice information, so as to generate conference records according to the voice text of the voice information and the corresponding user information.

Optionally, the voiceprint feature corresponding to the voice information collected by the terminal of the participating user is determined, and the user information corresponding to the voiceprint feature is determined, herein the user information includes a user name, a department, a company name, and so on.

In some embodiments, this embodiment determines voiceprint features in any one or more of the following modes.

Mode 1. the conference device performs voiceprint recognition.

During implementation, voice information collected by the terminal is received, voiceprint recognition is performed on the voice information, and voiceprint features corresponding to the voice information are determined.

Mode 2. the server performs voiceprint recognition, and the server sends the voiceprint features.

During implementation, the voiceprint features received from the server are determined as the voiceprint features corresponding to the voice information.

In some embodiments, the server receives the voice information sent by the terminal, performs voiceprint recognition on the voice information to obtain voiceprint features, and sends the voiceprint features to the conference device.

In some embodiments, the server receives the voice information of the terminal forwarded by the conference device, performs voiceprint recognition on the voice information to obtain voiceprint features, and sends the voiceprint features to the conference device.

Mode 3. the server performs voiceprint recognition, and the terminal sends voiceprint features.

During implementation, the voiceprint features received from the terminal are determined as the voiceprint features corresponding to the voice information.

In some embodiments, the terminal sends the voice information to the server for voiceprint recognition, and receives the voiceprint features sent by the server; and the terminal sends the voiceprint features to the conference device.

In some embodiments, the terminal forwards the voice information to the server through the conference device for voiceprint recognition, receives the voiceprint features sent by the server, and sends the voiceprint features to the conference device.

In some embodiments, the determining of the user name corresponding to the voiceprint feature includes any or more of the following.

Type 1: the conference device itself determines the user name corresponding to the voiceprint feature.

The conference device screens out the voiceprint information corresponding to the voiceprint feature from its own voiceprint database, and determines the user name corresponding to the voiceprint feature according to the registered user information corresponding to the voiceprint information.

In some embodiments, if the voiceprint information corresponding to the voiceprint feature is not screened out from the voiceprint database of the conference device, the user name corresponding to the voiceprint feature is determined according to the naming rule.

Type 2: the conference device determines the user name corresponding to the voiceprint feature through the connected edge end device.

Type 3: the conference device receives the user name sent by the server, and determines the received user name as the user name corresponding to the voiceprint feature.

In some embodiments, the voiceprint feature is determined according to the voice information whose volume satisfies a condition among the voice information collected by the terminals of the participating users.

In this embodiment, before performing voiceprint recognition, the voice information collected by the terminal can also be screened. Based on the principle that the farther the distance between the participating user and the terminal is, the smaller the volume of the participating user collected by the terminal is, the voice information collected by the terminal is initially screened in advance, and then the voiceprint recognition is performed on the voice information whose volume meets the condition, so as to extract the voiceprint information more accurately and improve the accuracy of voice recognition.

In some embodiments, it specifically includes any one or more of the following screening cases.

Case 1: the conference device screens voice information.

The conference device receives the voice information collected by the terminal, screens out voice information whose volume meets the condition from the collected voice information, performs voiceprint recognition on the screened voice information, and determines the voiceprint feature corresponding to the voice information.

Case 2: the server screens the voice information.

After receiving the collected voice information, the server screens out the voice information whose volume meets the condition from the collected voice information, performs voiceprint recognition on the screened voice information, and determines the voiceprint feature corresponding to the voice information.

Case 3: the terminal screens the voice information.

After the terminal collects the voice information, the terminal screens out the voice information whose volume meets the condition from the collected voice information, and sends the screened voice information to the server for voiceprint recognition, or forwards the screened voice information to the server through the conference device for voiceprint recognition.

In some embodiments, the user information corresponding to the voice information is determined by performing voiceprint recognition on the voice information collected by the terminal in the following manner.

Firstly, the voice information collected by the terminals is screened to obtain voice information whose volume satisfies the condition. During implementation, the voice information with the largest volume can be screened out, or the voice information with the largest volume can be screened out from voice information with a volume greater than a volume threshold. This embodiment does not make too many limitations on the implementation manner of how to screen out the volume satisfying the condition. In a specific situation, the corresponding setting of the satisfying condition of the volume may be performed according to the requirement for acquiring voice, and this embodiment does not make too many limitations on this.

Secondly, voiceprint recognition is performed on the voice information whose volume satisfies the condition, and the user information corresponding to the voice information is determined. During implementation, there are usually multiple users participating the conference, so there are multiple corresponding terminals. For any terminal, the voice information of the speaker may be collected, so the voice information collected by different terminals can be screened according to the volume, to recognize the screened voice information. It should be noted that when multiple speakers are speaking, the distance between each speaker and its own terminal is usually the shortest, so the voice information of the maximum volume collected by each speaker's terminal is usually the voice information of the speaker. Then the voice information of the corresponding speaker can be extracted from different terminals through the volume, so as to separate the voice information of multiple speakers speaking at the same time, and screen out the voice information of each speaker, thereby improving the accuracy of voice recognition, and further improving the accuracy of conference records.

In some embodiments, the voiceprint recognition is performed on the voice information collected by the terminal through the following steps to determine the user information corresponding to the voice information. Herein, the user information includes but is not limited to a user name, a company name, a gender, a position, a department and other information related to the participating user; and this embodiment does not make too many limitations on this.

In some embodiments, the conference device determines the voiceprint database by: obtaining the registered user information and registered voice information of the terminal; determining the voiceprint information corresponding to the registered voice information; establishing the corresponding relationship between the registered user information and the voiceprint information; and determining the voiceprint database according to the registered user information, the voiceprint Information and the corresponding relationship.

In some embodiments, in response to the user's first editing instruction for at least one of the voiceprint information or the registered user information in the voiceprint database, the conferencing device performs an editing operation on the content corresponding to the first editing instruction. The editing operation includes at least one of modification, addition, or deletion.

Step 1. voiceprint recognition is performed on the voice information collected by the terminal to obtain voiceprint features.

During implementation, the voiceprint recognition can be performed through a trained deep learning model (such as a voiceprint recognition model). The voice information is input into the voiceprint recognition model for voiceprint recognition, and corresponding voiceprint features are output.

In some embodiments, the voice recognition and voiceprint recognition can be performed simultaneously on the input voice information through the voice and voiceprint recognition model to obtain the corresponding voice text and voiceprint features. This embodiment does not make too many limitations on how to perform voice recognition and voiceprint recognition. This embodiment does not make too many limitations on the training samples and the training process of the involved deep learning model.

Step 2. whether there is voiceprint information matching the voiceprint feature in the voiceprint database is determined.

In some embodiments, the registered user information and corresponding voiceprint information are pre-stored in the voiceprint database, so that the obtained voiceprint feature can be compared with the stored voiceprint information, to determine the registered user information corresponding to the matched voiceprint information.

In some embodiments, the voiceprint database is determined through the following steps.

(1) The registered user information and the registered voice information of the terminal are obtained.

In some embodiments, the participating users can upload their own voiceprint information through the conference APP of their respective terminals. During implementation, the participating user can upload its own registered user information and registered voice information through registering a user by the conference APP. The registered user information includes but is not limited to a registration identification (ID), a company and a department and other user information required for participating in the conference. The registered voice information includes but is not limited to uploaded voice information with a fixed content. For example, users can be prompted to read aloud the displayed content on the APP registration interface, so as to collect the voice information of the registered users, and further obtain the voiceprint information and generate the voiceprint database through the following methods.

(2) Voiceprint recognition is performed on the registered voice information to obtain voiceprint information.

For the method and process of performing voiceprint recognition in this embodiment, reference may be made to the above content, and details are not repeated here. The voiceprint information in this example can also be understood as voiceprint features.

(3) A corresponding relationship between the registered user information and the voiceprint information is established, and the voiceprint database is determined according to the registered user information, the voiceprint information and the corresponding relationship.

In the implementation, the registered user information and the voiceprint information are stored in the voiceprint database, and each voiceprint information corresponds to one piece of registered user information, so that the voiceprint information that matches the voiceprint feature can be screened from the stored voiceprint information, and the corresponding registered user information is determined, to generate conference records.

Step 3. if the voiceprint information matching the voiceprint feature is screened from the voiceprint database, the user information corresponding to the voice information is determined according to the registered user information corresponding to the voiceprint information in the voiceprint database.

In this step, the voiceprint information matching the voiceprint feature can be found from the voiceprint database, and then according to the correspondence between voiceprint information and voiceprint features in the voiceprint database, the registered user information corresponding to the voiceprint information is determined to be the user information corresponding to the voice information.

Step 4. if the voiceprint information matching the voiceprint feature is not screened out from the voiceprint database, the voiceprint feature is named according to the naming rule, and the user information corresponding to the voice information is determined according to the named user information.

In this step, no voiceprint information matching the voiceprint feature is found from the voiceprint database, indicating that the voice information in this case is not the voice information of the participating user who has registered in the conference APP. Therefore, a name can be customized according to the predefined name rule, such as “unknown user 1”, “speaker 1” and other naming formats, which are not limited in this embodiment. The named user information is used as the user information corresponding to the voice information.

Here, the step 3 and the step 4 in this embodiment are executed in no particular order.

In some embodiments, the voice recognition and the voiceprint recognition can be simultaneously performed on the collected voice information, so as to determine the corresponding voice text and user name. The specific implementation process includes: determining the voice information collected by the terminal, screening out voice information whose volume meets the condition from the voice information, and performing the voice recognition and the voiceprint recognition on the screened voice information to obtain the corresponding voice text and user name.

In some embodiments, after screening the collected voice information through the conference device, the voice recognition and the voiceprint recognition are respectively performed on the screened voice information to obtain the corresponding voice text and user name. Alternatively, after screening the voice information through the server, the voice recognition and the voiceprint recognition are respectively performed on the screened voice information to obtain the corresponding voice text and user name. Alternatively, after screening the collected voice information through the terminal, the voice recognition and the voiceprint recognition are respectively performed on the screened voice information through the server to obtain the corresponding voice text and user name. Alternatively, after screening the collected voice information through the terminal, the voice recognition and the voice recognition are respectively performed on the screened voice information through the conference device to obtain the corresponding voice text and user name.

In some embodiments, in order to make the content of the conference records richer and more viewable, this embodiment provides multiple optional implementation modes for generating conference records, specifically as follows.

Mode 1. conference records are directly generated based on the voice text.

In this way, the voice information collected by the terminals of the participating users can be come together, and after screening and recognizing the voice information that is come together, the voice text that is come together can be obtained. And then, according to the timestamp of the voice information corresponding to each voice text, the voice texts are sorted to generate conference records.

Mode 2. conference records are generated according to the voice text and corresponding user information.

In this way, it is not only necessary to sort the voice texts, but also to determine the user information corresponding to each voice text, so as to associate each voice text with the corresponding user information; and finally according to the timestamp of the collected voice information, the voice texts are sorted to generate conference records. In the conference records generated by this method, the speech contents of the participating users can be displayed in sequence according to the order of the speaking time of the participating users.

In some embodiments, the conference records can also be generated by the server.

Optionally, the server performs voice recognition on the voice information to obtain the voice text, generates a conference record according to the voice text, and sends the conference record to the conference device, or forwards the conference record to the conference device through the terminal.

Optionally, the server performs voice recognition and voiceprint recognition on the voice information to obtain the corresponding voice text and the user name respectively, generates a conference record based on the voice text and user name, and sends the conference record to the conference device, or forwards the conference record to the conference device through the terminal.

It should be noted that the above scenario can be applied to the process of obtaining the voice information collected by the terminal in real time during the conference, performing voice recognition, generating the voice text, and finally generating conference records. During this process, the voice information is constantly increasing, the voice texts are also constantly increasing, and the conference records are also continuously improved with the speeches of the participants in the conference; and finally complete conference records are generated after the conference is over. Since in this embodiment, the voice information collected by the terminals of the participating users can be obtained, and the voice texts can be obtained through processing such as voice recognition, in the whole process, collection, recognition and other timely processing can be continuously performed along with proceeding of conference and speeches of participants.

In another scenario, such as the scenario after the conference ends, the uploaded voice file may also be processed as follows.

Process 1. the uploaded voice file is obtained.

During the implementation, the voice files uploaded by users can be obtained through the external interface. In this scenario, the voice files can be voice files recorded by some participants through other devices during the conference. In order to ensure the integrity and completeness of the conference records, the uploaded voice files can be obtained to supplement and improve the original conference records.

Process 2. voice recognition is performed on the uploaded voice information in the voice file, and the supplementary voice text of the uploaded voice information is determined.

Process 3. the conference record is generated according to the supplementary voice text and the determined voice text.

In some embodiments, in order to determine the user information corresponding to the supplementary voice text and add the user information to the conference record, this embodiment can also obtain the supplementary user information of the supplementary voice text in the following manner: performing voiceprint recognition on the uploaded voice information in the voice file, and determining the supplementary user information corresponding to the uploaded voice information. Further, the supplementary conference record is generated according to the supplementary voice text and the supplementary user information, and the supplementary conference record is added to the conference record generated based on the voice text.

In some embodiments, the supplementary conference record may be generated according to the supplementary voice text and corresponding supplementary user information, and the supplementary conference record is added to the conference record generated according to the voice text and corresponding user information.

In some embodiments, after the conference record is generated according to the voice text of the voice information, this embodiment can also generate a conference summary, specifically by any one or more of:
mode 1. identifying the key information in the voice text according to the text summarization algorithm, and generating a conference summary according to the identified key information;
mode 2. sending the conference record to the server, so that the server identifies the key information in the conference record according to the text summarization algorithm to obtain a conference summary; and receiving the conference summary sent by the server; or
mode 3. forwarding the conference record to the server through the terminal, so that the server identifies the key information in the conference record according to the text summarization algorithm to obtain a conference summary; and receiving the conference summary forwarded by the server through the terminal.

In some embodiments, after the conference record is generated according to the voice text of the voice information, this embodiment also provides any one or more of the following display modes.

Display mode 1. the conference record is displayed.

During implementation, the conference record may be displayed on at least one of the conference device or the terminals of the participating users. After the conference records are displayed, in response to the user's second editing instruction on the conference records, the corresponding editing operation is performed on the content corresponding to the second editing instruction, herein the editing operation includes at least one of modification, addition, or deletion. For example, the user can modify the content corresponding to user A in the displayed conference records, and can also modify the user information in the displayed conference records, for example, “unknown user 1” is modified to “user A”, that is to say, the name and content of the speaker in the conference records can be modified.

Display mode 2. the conference summary is displayed.

During implementation, the conference summary may be displayed on at least one of the conference device or the terminals of the participating users. After the conference summary is displayed, in response to the user's second editing instruction on the conference summary, the corresponding editing operation is performed on the content corresponding to the second editing instruction, herein the editing operation includes at least one of modification, addition, or deletion. For example, the user can modify the content corresponding to user A in the displayed conference summary, and can also modify the user information in the displayed conference summary, for example, “unknown user 1” is modified to “user A”, that is to say, the name (identification, ID) and content of the speaker in the conference summary can be modified.

In some embodiments, after the conference records are generated according to the voice texts of the voice information, in order to ensure that the participants can conveniently download and view the conference records, this embodiment can also generate the download link address corresponding to at least one of the conference records or the conference summary, and display the download link address on at least one of the conference end or the terminals.

During implementation, the download link address corresponding to the conference record can be generated and displayed on the conference end and/or terminals. The download link address corresponding to the conference summary can also be generated and displayed on the conference end and/or terminals. The download link addresses respectively corresponding to the conference record and the conference summary can also be generated and displayed on the conference end and/or terminals. One download link address corresponding to the conference record and the conference summary can also be generated and displayed on the conference end and/or terminals.

In some embodiments, the download link address includes, but is not limited to at least one form of a uniform resource locator (URL) address or a quick response (QR) code.

In some embodiments, after determining the voice text corresponding to the voice information collected by the terminal of the participating user, the embodiments further include any one or more of the following implementations:
implementation 1. the conference device directly translates the voice text into a translated text corresponding to a preset language type;
implementation 2. the conference device translates the voice text into a translated text corresponding to a preset language type through the connected edge end device; or
implementation 3. the server translates the voice text into a translated text corresponding to a preset language type, and sends the translated text to the conference device; and the conference device determines the translated text received from the server as the translated text corresponding to the voice text.

In some embodiments, in the conference process, after the voice information of the participating user who is speaking is recognized to obtain the voice text, the following method can also be provided to display the content of the participating user who is speaking, so as to improve the user experience of conference interaction.

In some embodiments, the real-time display of the voice text can be implemented by any one or more of the following modes, herein the real-time display in this embodiment represents instant display within the allowable delay range:
mode a. sending the voice text obtained after the voice recognition to the conference end, and controlling the conference end to display the voice text in real time;
mode b. translating the voice text obtained after voice recognition into a voice text of a preset language type and sending the translated voice text to the conference end, and controlling the conference end to display the translated voice text in real time; or
mode c. sending the voice text that belongs to the preset language type directly to the conference end, and translating the voice text that does not belong to the preset language type into the voice text of the preset language type and sending the translated voice text to the conference end, and controlling the conference end to display the translated voice text in real time.

In some embodiments, the voice text content of the current voice information of the speaker is displayed in real time on the conference end, so that other participating users who cannot hear the speaker's voice information clearly can learn about the content of the current speaker's voice information by displaying on the conference end, thereby improving the efficiency of conference interaction.

In some embodiments, the voiceprint information and the corresponding registered user information stored in the voiceprint database in the embodiments can be edited by the user, that is, the information stored in the voiceprint database is editable, and the user can edit it according to actual needs. For example, the stored voiceprint information can be deleted, the registered user information can be modified, and new voiceprint information and corresponding registered user information can be added. For example, the voiceprint information of the collected voice information of the unknown speaker can be stored in the voiceprint database, and the voiceprint information can also be named to determine the corresponding registered user information, that is, the unknown speaker; and the user information of the unknown speaker can also be modified to, for example, the user B.

In some embodiments, the user can edit at least one of the voiceprint information or registered user information in the voiceprint database by accessing the voiceprint database through the conference end; and the editing operation includes at least one of modification, addition, or deletion.

In some embodiments, in response to a user's first editing instruction for at least one of the voiceprint information or registered user information in the voiceprint database, a corresponding editing operation is performed on the content corresponding to the first editing instruction.

In some embodiments, before the conference starts, the participants can also scan the QR code of the APP displayed on the conference end through their respective terminals to download the corresponding conference APP, or the participants can also use other links, an app store and the like to download the conference APP; and the conference APP is used to pick up the voice of the participants and perform basic audio filtering functions. During implementation, it can also realize the communication connection with the device end corresponding to the method for recording the conference in this embodiment through the conference APP, so as to transmit the participants' voice picked up by each terminal to the device end. The device end is used to implement the contents of the method for recording conference in this embodiment, including but not limited to: at least one of the following functions: obtaining voice information, voice recognition, storing user information, voiceprint feature information, generating conference records, or generating text summaries.

In some embodiments, the conference APP can also be installed on the conference end, so as to realize the communication connection between the conference end and the device end corresponding to the method for recording the conference in this embodiment through the conference APP, to realize functions, such as displaying the QR code and subtitles, and displaying conference records.

In some embodiments, the device end corresponding to the method for displaying the conference content in this embodiment includes, but is not limited to, any one or more of the following multifunctional modules: a service module, a voice module, and a text summarization module, herein the service module includes but is not limited to an application programming interface (API) invocation module and the database module.

The service module is configured to realize the functions of the conference APP, including the encapsulation of the API interface and the external provision of the API interface; herein, the API invocation module is configured to realize the information interaction between various functional modules through invocation; and the database module is configured to store registered user information, voiceprint information, voice information, voice texts, conference records, the conference summaries and other information that need to be stored.

The voice module is configured to perform voice recognition and voiceprint recognition on the real-time voice information, and further configured to perform voice recognition and voiceprint recognition on uploaded voice files.

The text summarization module is configured to identify key information in the voice text according to a text summarization algorithm, and generate the conference summary according to the identified key information.

In some embodiments, at least part of the functional modules can be integrated on the conference device, for example, the service module can be integrated on the conference device, so that the voice recognition module, the text summarization module, etc. can be used as independent service devices. Various functional modules can also be integrated into an independent service device and the independent service device is deployed in the local area network where the conference device is located, or various functional modules can be integrated into an independent edge end device (including but not limited to an edge development mainboard, an OPS, etc.), for direct connection between the edge end device with the conference device.

In some embodiments, since real-time voice recognition has real-time performance requirements, the voice module can bypass the service module and directly communicate with the conference device, and the voice module can also bypass the service module and directly communicate with the terminal, so that the voice collected by the terminal is sent to the voice module for voice recognition and/or voiceprint recognition through streaming transmission, the voice text is directly sent to the conference end, and the speech contents of the participants can be displayed in real time, to effectively improve the interactive experience of the conference.

As shown in FIG. 2, the embodiments provide a conference system, including a user terminal 200, a conference device 201, and optionally, a server 202, wherein:
there is one or more user terminals 200, and there is one or more conference devices 201;
the user terminal 200 is configured to collect voice information; and
the conference device 201 is configured to determine the voice text corresponding to the voice information collected by the user terminal and display the conference content related to the voice text, and further configured to display the conference content, the QR code of the conference, the conference record, the voice text (also known as subtitles), etc.

In some embodiments, the interaction process between the user terminal 200 and the conference device 201 in this embodiment is as follows:
the user terminal sends the collected voice information to the conference device; and the conference device performs voice recognition on the voice information to obtain a voice text; or,
the user terminal sends the collected voice information to the conference device; and the conference device performs voiceprint recognition on the voice information to obtain the voiceprint feature, and determines a user name corresponding to the voiceprint feature; or,
the user terminal sends the collected voice information to the conference device; and the conference device performs voice recognition on the voice information to obtain the voice text, performs voiceprint recognition to obtain the voiceprint feature, and determines a user name corresponding to the voiceprint feature.

In some embodiments, this embodiment further includes a server 202, specifically including at least one of a service module 202a, a voice module 202b, or a text summarization module 202c.

Herein, the service module 202a is configured to realize functions of the conference APP, including the encapsulation of the API interface and the external provision of the API interface. The service module 202a specifically includes: an API invocation module and a database module; herein the API invocation module is configured to realize the information interaction between various functional modules by invocation; and the database module is configured to store registered user information, voiceprint information, voice information, voice texts, conference records, conference summaries and other information that need to be stored.

The voice module 202b is configured to perform voice recognition and voiceprint recognition on the real-time voice information, and further configured to perform voice recognition and voiceprint recognition on uploaded voice files.

The text summarization module 202c is configured to identify the key information in the voice text according to the text summarization algorithm, and generate the conference summary according to the identified key information.

In some embodiments, the service module 202a can be integrated in the conference device 201, or the server 202 can be integrated in the conference device 201. In order to realize real-time voice recognition, while the voice module 202b performing voice recognition can be directly connected to the terminal of the participating user to obtain the collected voice information, and directly sends the recognized voice text to the conference device 201, avoiding the delay caused by forwarding through the service module 202a, and improving the processing speed of voice recognition to a certain extent.

In some embodiments, the interaction process of voice information combined with the server 202 in this embodiment is as follows:
the user terminal sends the collected voice information to the server; or,
the user terminal sends the collected voice information to the conference device, and the conference device forwards the voice information to the server.

In some embodiments, after the server receives the voice information, the server in this embodiment is further configured to:
perform voice recognition on the voice information to obtain a voice text; or,
perform voiceprint recognition on the voice information to obtain a voiceprint feature, and determine a user name corresponding to the voiceprint feature; or,
perform voice recognition on the voice information to obtain a voice text, perform voiceprint recognition to obtain a voiceprint feature, and determine a user name corresponding to the voiceprint feature.

In some embodiments, if the server performs voice recognition on the voice information and determines the voice text, the server in this embodiment is further configured to: send the voice text to the user terminal, so that the user terminal sends the voice text to the conference device; or, send the voice text to the conference device.

In some embodiments, if the server performs voiceprint recognition on the voice information and determines the voiceprint feature, the server in this embodiment is further configured to:
send the voiceprint feature to the user terminal, so that the user terminal sends the voiceprint feature to the conference device; or,
send the voiceprint feature to the conference device.

In some embodiments, at least the following four implementation modes can be obtained by combining the above-mentioned processes for processing the voice information:
mode 1. the user terminal sends the collected voice information to the conference device; and the conference device performs voice recognition on the voice information to obtain a voice text. In this mode, the conference device establishes a communication connection with the user terminal, and receives the voice information collected by the user terminal through streaming transmission; and performs voice recognition on the voice information through the connected edge end device, to obtain the voice text;
mode 2. the user terminal sends the collected voice information to the server; the server performs voice recognition on the voice information to obtain a voice text, and sends the voice text to the user terminal; and the user terminal sends the voice text to the conference device;
mode 3. the user terminal sends the collected voice information to the conference device; the conference device forwards the voice information to the server; and the server performs voice recognition on the voice information to obtain a voice text, and sends the voice text to the conference device; and
mode 4. the user terminal performs voice recognition on the collected voice information to obtain a voice text, and sends the voice text to the conference device.

In some embodiments, the voice text is determined according to voice information whose volume satisfies a condition among the voice information collected by the user terminal.

It should be noted that, in the process of performing voice recognition on the voice information in this embodiment, the voiceprint recognition can also be performed on the voice information at the same time, to determine the voiceprint feature corresponding to the voice information; and the voiceprint feature is matched with the voiceprint information in the voiceprint database, to determine the user information corresponding to the voice information.

In some embodiments, the voiceprint feature is determined according to voice information whose volume satisfies a condition among the voice information collected by the user terminal.

During implementation, the voice information collected by the terminal can be screened to obtain voice information whose volume satisfies the condition; and voice recognition is performed on the voice information whose volume meets the condition to determine the voice text of the voice information. Optionally, the process of screening the voice information may be performed by the user terminal, the conference device, or the server.

In some embodiments, the process of screening the voice information and the process of performing voice recognition and voiceprint recognition on the voice information are executed by the same entity. During implementation, the voice information can be screened through the server, and voice recognition and voiceprint recognition can be performed on the screened voice information. The voice information can also be screened through the conference device, and voice recognition and voiceprint recognition can be performed on the screened voice information.

In some embodiments, the conference device is further configured to:
generate the conference record according to the voice text; or,
generate the conference record according to the voice text and the user name corresponding to the voice text.

In some embodiments, the server is further configured to:
generate the conference record according to the voice text; or,
generate the conference record according to the voice text and the user name corresponding to the voice text.

Both the conference device and the server in the embodiments have the function of generating the conference record. The conference device or the server can be chose to generate the conference record according to actual needs. If the server generates the conference record, the server can send the conference record to the conference device.

In some embodiments, voiceprint recognition is performed on the voice information collected by the terminal to obtain the voiceprint feature; if the voiceprint information matching the voiceprint feature is screened out from the voiceprint database, the user information corresponding to the voice information is determined according to the registered user information corresponding to the voiceprint information in the voiceprint database; if the voiceprint information matching the voiceprint feature is not screened out from the voiceprint database, the voiceprint feature is named according to the naming rule, and the user information corresponding to the voice information is determined according to the named user information.

In some embodiments, the conference device can obtain the registered user information and registered voice information of the terminal, perform voiceprint recognition on the registered voice information to obtain voiceprint information, establish a correspondence between the registered user information and the voiceprint information, and determine the voiceprint database according to the registered user information, the voiceprint information, and the correspondence.

In some embodiments, in response to the user's first editing instruction for at least one of the voiceprint information or registered user information in the voiceprint database, the conference device performs an editing operation on the content corresponding to the first editing instruction; herein the editing operation includes at least one of modification, addition, or deletion.

In some embodiments, the conference device establishes a communication connection with the terminal of the user participating in the conference, and obtains the voice information collected by the terminal of the user participating in the conference through streaming transmission.

In some embodiments, the conference device identifies key information in the conference record according to a text summarization algorithm, and generates the conference summary according to the identified key information; or,
the conference device sends the conference record to the server; and the server identifies key information in the conference record according to a text summarization algorithm to obtain the conference summary, and sends the conference summary to the conference device; or,
the conference device forwards the conference record to the server through the terminal; and the server identifies key information in the conference record according to a text summarization algorithm to obtain the conference summary, and forwards the conference summary through the terminal to the conference device.

In some embodiments, the conference device is further configured to: generate a download link address corresponding to at least one of the conference record or the conference summary.

In some embodiments, the conference device translates the voice text into a translated text corresponding to a preset language type, and displays the translated text; or,
the conference device translates the voice text into a translated text corresponding to the preset language type through the connected edge end device, and displays the translated text; or,
the server translates the voice text into a translated text corresponding to a preset language type, and sends the translated text to the conference device. The conference device may also be controlled to display the voice text.

In some embodiments, the key information in the voice text is identified according to a text summarization algorithm, and the conference summary is generated according to the identified key information.

In some embodiments, at least one of the conference record or the conference summary is displayed; and in response to a user's second editing instruction for at least one of the conference record or the conference summary, a corresponding editing operation is performed on the content corresponding to the second editing instruction, herein the editing operation includes at least one of modification, addition, or deletion.

In some embodiments, the conference device generates a download link address corresponding to at least one of the conference record or the conference summary, and displays the download link address on at least one of the conference device or the terminal.

In some embodiments, the conference device is further configured to display the conference content related to the voice text through any one or more display modes as follows:
displaying the voice text in real time;
displaying the user name corresponding to the voice text in real time;
displaying a conference record related to the voice text;
displaying a conference summary related to the voice text;
displaying a translated text of a preset language type translated from the voice text in real time;
displaying a download link address corresponding to the conference record related to the voice text; or
displaying a download link address corresponding to the conference summary related to the voice text.

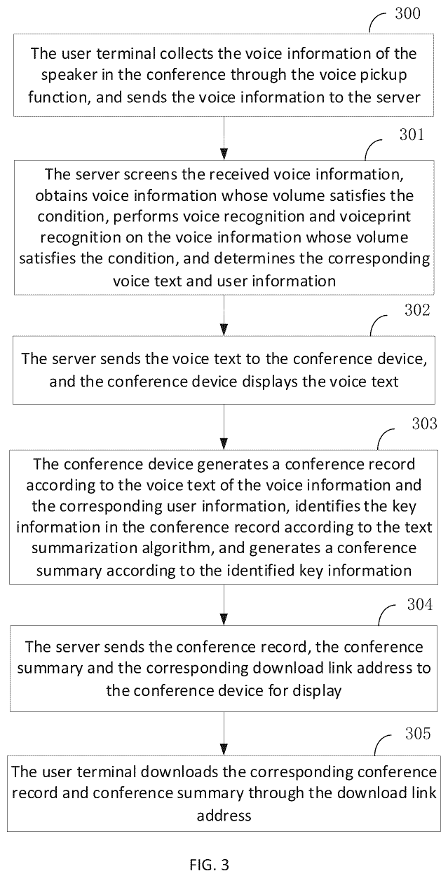

As shown in FIG. 3, based on the above conference system, the implementation process of the method for recording the conference provided by this embodiment is as follows:
step 300. the user terminal collects the voice information of the speaker in the conference through the voice pickup function, and sends the voice information to the server;
step 301. the server screens the received voice information, obtains voice information whose volume satisfies the condition, performs voice recognition and voiceprint recognition on the voice information whose volume satisfies the condition, and determines the corresponding voice text and user information;
step 302. the server sends the voice text to the conference device, and the conference device displays the voice text;
step 303. the conference device generates a conference record according to the voice text of the voice information and the corresponding user information, identifies the key information in the conference record according to the text summarization algorithm, and generates a conference summary according to the identified key information;
step 304. the server sends the conference record, the conference summary and the corresponding download link address to the conference device for display; and
step 305. the user terminal downloads the corresponding conference record and conference summary through the download link address.

The user terminal for downloading the conference record and the conference summary may be a terminal of a participating user or a terminal of a user that does not participate in the conference, which is not limited in the embodiments.

In some embodiments, this embodiment provides a specific process of recording the conference. Herein, before the conference starts, the conference APP can be downloaded and installed on the terminals of the participating users, and the conference APP can also be downloaded and installed on the conference device, so that the conference device, user terminals and the server participating in this smart conference can all establish a communication connection. After that, the QR code of the conference is displayed on the conference device; and the participating users scan the QR code of the conference through the conference APP of their respective terminals, and register, herein the registered items mainly include inputting the registered user information and voiceprint information. The server stores the obtained registered user information and voiceprint information in the voiceprint database. At this point, the preparatory work is completed and the conference begins.

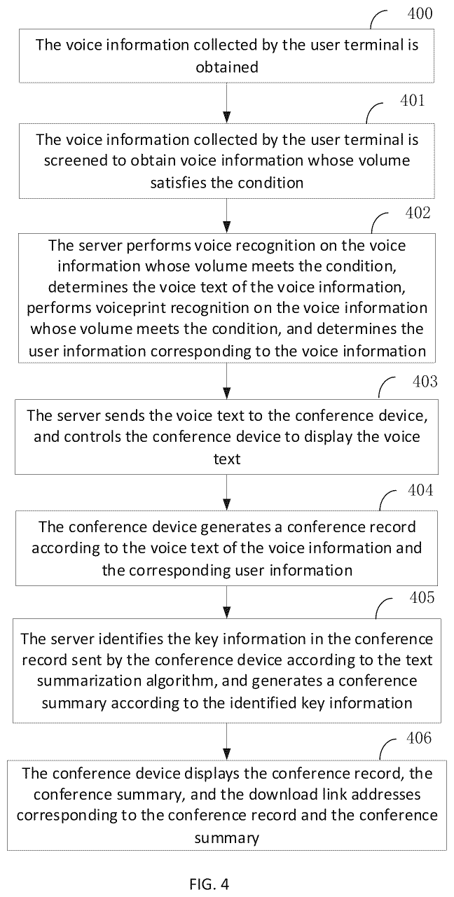

During the conference, as shown in FIG. 4, the flow of recording the conference is as follows:
step 400. the voice information collected by the user terminal is obtained;
step 401. the voice information collected by the user terminal is screened to obtain voice information whose volume satisfies the condition;
step 402. the server performs voice recognition on the voice information whose volume meets the condition, determines the voice text of the voice information, performs voiceprint recognition on the voice information whose volume meets the condition, and determines the user information corresponding to the voice information;
step 403. the server sends the voice text to the conference device, and controls the conference device to display the voice text;
step 404. the conference device generates a conference record according to the voice text of the voice information and the corresponding user information;
step 405. the server identifies the key information in the conference record sent by the conference device according to the text summarization algorithm, and generates a conference summary according to the identified key information; and
step 406. the conference device displays the conference record, the conference summary, and the download link addresses corresponding to the conference record and the conference summary.

Embodiment 2: based on the same inventive concept, the embodiments of the present disclosure further provide a conference device. Since the conference device is the device in the method in the embodiments of the present disclosure, and the problem-solving principle of the device is similar to that of the method, the implementation of the device can refer to the implementation of the method, and the repetition will be omitted.

As shown in FIG. 5, the conference device includes a processor 500 and a memory 501. The memory 501 is configured to store programs executable by the processor 500. The processor 500 is configured to read the programs in the memory 501 and execute:
determining the voice text corresponding to the voice information collected by the terminal of the participating user; and
displaying the conference content related to the voice text.

As an optional implementation manner, the processor 500 is specifically configured to execute:

receiving the voice information collected by the terminal, performing voice recognition on the voice information, and determining the voice text corresponding to the voice information.

As an optional implementation manner, the processor 500 is specifically configured to execute:

receiving the voice text, and determining the received voice text as the voice text corresponding to the voice information.

As an optional implementation manner, the processor 500 is specifically configured to execute:
receiving the voice text sent by the server; or,
receiving the voice text sent by the terminal.

As an optional implementation manner, the processor 500 is specifically configured to execute:

performing voice recognition on the voice information through the connected edge end device, and determining the voice text corresponding to the voice information.

As an optional implementation manner, the voice text sent by the server is obtained by: the server receiving the voice information sent by the terminal and performing voice recognition on the voice information; or,

the voice text sent by the server is obtained by: the server receiving the voice information of the terminal forwarded by the conference device and performing voice recognition on the voice information.

As an optional implementation manner, the voice text sent by the terminal is obtained by: the terminal sending the voice information to the server for voice recognition, and receiving the voice text sent by the server; or,

the voice text sent by the terminal is obtained by: the terminal performing voice recognition on the voice information.

As an optional implementation manner, the voice text is determined according to the voice information whose volume satisfies a condition among the voice information collected by the terminal of the participating user.

As an optional implementation manner, the processor 500 is specifically configured to execute:

establishing a communication connection with the terminal, and receiving the voice information collected by the terminal through streaming transmission.

As an optional implementation manner, the voice text further includes user information; and the user information is determined according to the voiceprint feature corresponding to the voice information, and the voiceprint feature is obtained by performing voiceprint recognition on the voice information.

As an optional implementation manner, after determining the voice text corresponding to the voice information collected by the terminal of the participating user, the processor 500 is specifically further configured to execute:
generating a conference record according to the voice text; or,
generating a conference record according to the voice text and user information corresponding to the voice text.

As an optional implementation manner, after the conference record is generated, the processor 500 is specifically further configured to execute:
identifying key information in the conference record according to a text summarization algorithm, and generating a conference summary according to the identified key information; or,
sending the conference record to the server, so that the server identifies key information in the conference record according to a text summarization algorithm to obtain a conference summary; and receiving the conference summary sent by the server; or,
forwarding the conference record to the server through the terminal, so that the server identifies the key information in the conference record according to the text summarization algorithm to obtain a conference summary; and receiving the conference summary forwarded by the server through the terminal.

As an optional implementation manner, the processor 500 is specifically further configured to execute:

generating a download link address corresponding to at least one of the conference record or the conference summary.

As an optional implementation manner, after the conference record is generated, the processor 500 is specifically further configured to execute:
obtaining the voice file uploaded locally, and determining the supplementary voice text and the supplementary voiceprint feature corresponding to the uploaded voice information in the voice file;
generating a supplementary conference record according to the supplementary voice text and the supplementary user information corresponding to the supplementary voiceprint feature; and
updating the conference record by using the supplementary conference record.

As an optional implementation manner, after determining the voice text corresponding to the voice information collected by the terminal of the participating user, the processor 500 is specifically further configured to execute:
directly translating the voice text into a translated text corresponding to a preset language type; or,
translating the voice text into a translated text corresponding to a preset language type through the connected edge end device; or,
determining the translated text received from the server as the translated text corresponding to the voice text.

As an optional implementation manner, the processor 500 is specifically configured to execute:
displaying the voice text in real time; and/or,
displaying the user name corresponding to the voice text in real time; and/or,
displaying a conference record related to the voice text; and/or,
displaying a conference summary related to the voice text; and/or,
displaying a translated text of a preset language type translated from the voice text in real time; and/or,
displaying a download link address corresponding to the conference record related to the voice text; and/or,
displaying a download link address corresponding to the conference summary related to the voice text.

As an optional implementation manner, after displaying the conference content related to the voice text, the processor 500 is specifically further configured to execute:

in response to the user's second editing instruction for at least one of the conference record or the conference summary, performing a corresponding editing operation on the content corresponding to the second editing instruction; herein the editing operation includes at least one of modification, addition, or deletion.

Embodiment 3: based on the same inventive concept, the embodiments of the present disclosure further provide a device for displaying the conference content. Since the device for displaying the conference content is a device mentioned in the method in the embodiments of the present disclosure, and the problem-solving principle of the device is the similar to that of the method, so the implementation of the device can refer to the implementation of the method, and the repetition will be omitted.

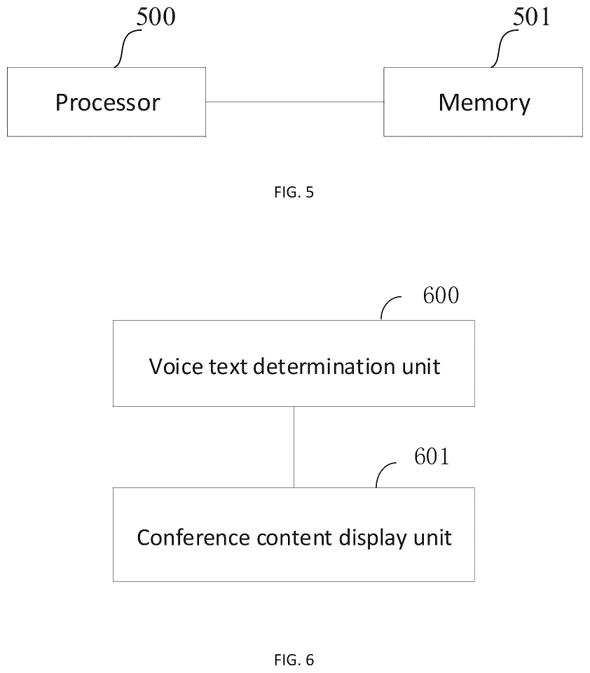

As shown in FIG. 6, the device includes:
a voice text determination unit 600, configured to determine the voice text corresponding to the voice information collected by the terminal of the participating user; and
a conference content display unit 601, configured to display the conference content related to the voice text.

As an optional implementation manner, the voice text determination unit 600 is specifically configured to:

receive the voice information collected by the terminal, perform voice recognition on the voice information, and determine the voice text corresponding to the voice information.

As an optional implementation manner, the voice text determination unit 600 is specifically configured to:

receive a voice text, and determine the received voice text as the voice text corresponding to the voice information.

As an optional implementation manner, the voice text determination unit 600 is specifically configured to:
receive the voice text sent by the server; or,
receive the voice text sent by the terminal.

As an optional implementation manner, the voice text determination unit 600 is specifically configured to:

perform voice recognition on the voice information through the connected edge end device, and determine the voice text corresponding to the voice information.

As an optional implementation manner, the voice text sent by the server is obtained by: the server receiving voice information sent by the terminal and performing voice recognition on the voice information; or,

the voice text sent by the server is obtained by: the server receiving the voice information of the terminal forwarded by the conference device and performing voice recognition on the voice information.

As an optional implementation manner, the voice text sent by the terminal is obtained by: the terminal sending voice information to a server for voice recognition and receiving the voice text sent by the server; or,

the voice text sent by the terminal is obtained by: the terminal forwarding the voice information to the server through the conference device for voice recognition, and receiving the voice text sent by the server.

As an optional implementation manner, the voice text is determined according to the voice information whose volume satisfies a condition among the voice information collected by the terminal of the participating user.

As an optional implementation manner, the voice text determination unit 600 is specifically configured to:

establish a communication connection with the terminal, and receive the voice information collected by the terminal through streaming transmission.

As an optional implementation manner, the voice text further includes user information, the user information is determined according to the voiceprint feature corresponding to the voice information, and the voiceprint feature is obtained by performing voiceprint recognition on the voice information.

As an optional implementation manner, the device further includes a conference record generation unit configured to:
generate a conference record according to the voice text; or,
generate a conference record according to the voice text and user information corresponding to the voice text.

As an optional implementation manner, the device further includes a conference summary determination unit configured to:
identify key information in the conference record according to a text summarization algorithm, and generate a conference summary according to the identified key information; or,
send the conference record to the server, so that the server identifies key information in the conference record according to a text summarization algorithm to obtain a conference summary; and receive the conference summary sent by the server; or,
forward the conference record to the server through the terminal, so that the server identifies the key information in the conference record according to the text summarization algorithm to obtain a conference summary; and receive the conference summary forwarded by the server through the terminal.

As an optional implementation manner, the device further includes a download link generation unit configured to:

generate a download link address corresponding to at least one of the conference record or the conference summary.

As an optional implementation manner, the device further includes a conference update unit configured to:
obtain the voice file uploaded locally, and determine the supplementary voice text and the supplementary voiceprint feature corresponding to the uploaded voice information in the voice file;
generate a supplementary conference record according to the supplementary voice text and the supplementary user information corresponding to the supplementary voiceprint feature;
and updating the conference record by using the supplementary conference record.

As an optional implementation manner, the device further includes a translation unit configured to:
directly translate the voice text into a translated text corresponding to a preset language type; or,
translate the voice text into a translated text corresponding to a preset language type through the connected edge end device; or,
determine the translated text received from the server as the translated text corresponding to the voice text.

As an optional implementation manner, the conference content display unit 601 is specifically configured to:
display the voice text in real time;
display the user name corresponding to the voice text in real time;
display a conference record related to the voice text;
display a conference summary related to the voice text;
display a translated text of a preset language type translated from the voice text in real time;
display a download link address corresponding to the conference record related to the voice text;
display a download link address corresponding to the conference summary related to the voice text.

As an optional implementation manner, the device further includes an editing unit configured to:

in response to the user's second editing instruction for at least one of the conference record or conference summary, perform a corresponding editing operation on the content corresponding to the second editing instruction; herein the editing operation includes at least one of modification, addition, or deletion.

Based on the same inventive concept, the embodiments of the present disclosure further provide a computer storage medium on which computer programs are stored; and when executed by a processor, the programs implement:
determining the voice text corresponding to the voice information collected by the terminal of the participating user; and
displaying the conference content related to the voice text.

Those skilled in the art should understand that the embodiments of the present disclosure may be provided as methods, systems, or computer program products. Accordingly, the present disclosure can take the form of an entire hardware embodiment, an entire software embodiment, or an embodiment combining software and hardware aspects. Furthermore, the present disclosure may take the form of a computer program product embodied on one or more computer-usable storage media (including but not limited to the disk storage, compact disc read-only memory (CD-ROM), optical storage, etc.) having computer-usable program code embodied therein.

The present disclosure is described with reference to flowchart illustrations and/or block diagrams of methods, apparatus (systems), and computer program products according to embodiments of the disclosure. It should be understood that each procedure and/or block in the flowchart and/or block diagram, and a combination of procedures and/or blocks in the flowchart and/or block diagram can be realized by computer program instructions. These computer program instructions may be provided to a general purpose computer, special purpose computer, embedded processor, or processor of other programmable data processing equipment to produce a machine, such that the instructions executed by the processor of the computer or other programmable data processing equipment produce an apparatus for realizing the functions specified in one or more procedures of the flowchart and/or one or more blocks of the block diagram.

These computer program instructions may also be stored in a computer-readable memory capable of directing a computer or other programmable data processing equipment to operate in a specific manner, such that the instructions stored in the computer-readable memory produce an article of manufacture including instruction devices, and the instruction device realizes the function specified in one or more procedures of the flowchart and/or one or more blocks of the block diagram.

These computer program instructions can also be loaded onto a computer or other programmable data processing equipment, causing a series of operational steps to be performed on the computer or other programmable equipment to produce a computer-implemented process, thereby the instructions performed on the computer or other programmable equipment provide steps for implementing the functions specified in one or more procedures of the flowchart and/or one or more blocks of the block diagram.

While preferred embodiments of the disclosure have been described, additional changes and modifications to these embodiments can be made by those skilled in the art once the basic inventive concept is appreciated. Therefore, it is intended that the appended claims be construed to cover the preferred embodiment as well as all changes and modifications which fall within the scope of the disclosure.

Apparently, those skilled in the art can make various modifications and variations to the embodiments of the present disclosure without departing from the spirit and scope of the embodiments of the present disclosure. In this way, if the modifications and variations of the embodiments of the present disclosure fall within the scope of the claims of the present disclosure and equivalent technologies, the present disclosure also intends to include these modifications and variations.

1-32. (canceled)

33. A method for displaying a conference content, applied to a conference device, wherein the method comprises:
determining a voice text corresponding to voice information collected by a terminal of a participating user; and
displaying the conference content related to the voice text.

34. The method according to claim 33, wherein the determining of the voice text corresponding to the voice information collected by the terminal of the participating user, comprises:
receiving the voice information collected by the terminal, performing voice recognition on the voice information, and determining the voice text corresponding to the voice information.

35. The method according to claim 33, wherein the determining of the voice text corresponding to the voice information collected by the terminal of the participating user, comprises:
receiving a voice text, and determining the received voice text as the voice text corresponding to the voice information;
wherein the receiving of the voice text comprises: receiving the voice text sent by a server; or, receiving the voice text sent by the terminal;
wherein, the voice text sent by the server is obtained by: the server receiving the voice information sent by the terminal and performing voice recognition on the voice information; or,
the voice text sent by the server is obtained by: the server receiving the voice information of the terminal forwarded by the conference device and performing voice recognition on the voice information; or,
the voice text sent by the terminal is obtained by: the terminal sending the voice information to the server for voice recognition and receiving the voice text sent by the server; or,
the voice text sent by the terminal is obtained by: the terminal performing voice recognition on the voice information.

36. The method according to claim 33, wherein the voice text is determined according to voice information whose volume satisfies a condition among the voice information collected by the terminal of the participating user.

37. The method according to claim 34, wherein an operation of performing voice recognition on the voice information and determining the voice text corresponding to the voice information, comprises:
performing voice recognition on the voice information through a connected edge end device, and determining the voice text corresponding to the voice information.

38. The method according to claim 35, wherein the receiving of the voice information collected by the terminal, comprises:
establishing a communication connection with the terminal, and receiving the voice information collected by the terminal through streaming transmission.

39. The method according to claim 33, wherein the voice text further comprises user information;
wherein the user information is determined according to a voiceprint feature corresponding to the voice information; and the voiceprint feature is obtained by performing voiceprint recognition on the voice information;
wherein after determining the voice text corresponding to the voice information collected by the terminal of the participating user, the method further comprises:
generating a conference record according to the voice text; or,
generating a conference record according to the voice text and user information corresponding to the voice text.

40. The method according to claim 39, wherein after generating the conference record, the method further comprises:
identifying key information in the conference record according to a text summarization algorithm, and generating a conference summary according to the identified key information; or,
sending the conference record to a server, so that the server identifies key information in the conference record according to a text summarization algorithm to obtain a conference summary; and receiving the conference summary sent by the server; or,
forwarding the conference record to a server through the terminal, so that the server identifies key information in the conference record according to a text summarization algorithm to obtain a conference summary; and receiving the conference summary forwarded by the server through the terminal;
wherein the method further comprises: generating a download link address corresponding to at least one of the conference record or the conference summary.

41. The method according to claim 39, wherein after generating the conference record, the method further comprises:
obtaining a voice file uploaded locally, and determining a supplementary voice text and a supplementary voiceprint feature corresponding to uploaded voice information in the voice file;
generating a supplementary conference record according to the supplementary voice text and supplementary user information corresponding to the supplementary voiceprint feature; and
updating the conference record by using the supplementary conference record.

42. The method according to claim 33, wherein after determining the voice text corresponding to the voice information collected by the terminal of the participating user, the method further comprises:
directly translating the voice text into a translated text corresponding to a preset language type; or,
translating the voice text into a translated text corresponding to a preset language type through a connected edge end device; or,
determining a translated text received from a server as a translated text corresponding to the voice text.

43. The method according to claim 33, wherein the displaying of the conference content related to the voice text, comprises at least one of:
displaying the voice text in real time;
displaying a user name corresponding to the voice text in real time;
displaying a conference record related to the voice text;
displaying a conference summary related to the voice text;
displaying a translated text of a preset language type translated from the voice text in real time;
displaying a download link address corresponding to a conference record related to the voice text; or
displaying a download link address corresponding to a conference summary related to the voice text;
wherein after displaying the conference content related to the voice text, the method further comprises:
in response to a user's second editing instruction for at least one of the conference record or the conference summary, performing an editing operation on a content corresponding to the second editing instruction;
wherein the editing operation comprises at least one of modification, addition, or deletion.

44. A conference system, comprising a user terminal and a conference device, wherein:
the user terminal is configured to collect voice information; and
the conference device is configured to: determine a voice text corresponding to the voice information collected by the user terminal, and display a conference content related to the voice text.

45. The conference system according to claim 44, wherein, the user terminal is configured to send the collected voice information to the conference device; and
the conference device is configured to perform voice recognition on the voice information to obtain the voice text.

46. The conference system according to claim 44, further comprising a server;
wherein the user terminal is configured to send the collected voice information to the server; the server is configured to perform voice recognition on the voice information to obtain the voice text, and send the voice text to the user terminal; and the user terminal is configured to send the voice text to the conference device; or,
the user terminal is configured to send the collected voice information to the conference device; the conference device is configured to forward the voice information to the server; and the server is configured to perform voice recognition on the voice information to obtain the voice text, and send the voice text to the conference device.

47. The conference system according to claim 44, wherein the user terminal is further configured to: perform voice recognition on the collected voice information to obtain the voice text, and send the voice text to the conference device.

48. The conference system according to claim 44, wherein the voice text is determined according to voice information whose volume satisfies a condition among the voice information collected by the user terminal.

49. The conference system according to claim 45, wherein the conference device is configured to perform voice recognition on the voice information through a connected edge end device to obtain the voice text.

50. The conference system according to claim 45, wherein the conference device is configured to: establish a communication connection with the user terminal, and receive the voice information collected by the user terminal through streaming transmission.

51. The conference system according to claim 44, wherein the voice text further comprises user information;
wherein the user information is determined according to a voiceprint feature corresponding to the voice information, and the voiceprint feature is obtained by performing voiceprint recognition on the voice information;
wherein the conference device is further configured to:
generate a conference record according to the voice text; or,
generate a conference record according to the voice text and a user name corresponding to the voice text;
wherein, the conference device is configured to: identify key information in the conference record according to a text summarization algorithm, and generate a conference summary according to the identified key information; or,
the conference device is configured to send the conference record to a server; and the server is configured to identify key information in the conference record according to a text summarization algorithm to obtain a conference summary, and send the conference summary to the conference device; or,
the conference device is configured to forward the conference record to a server through the terminal; and the server is configured to: identify key information in the conference record according to a text summarization algorithm to obtain a conference summary, and forward the conference summary through the terminal to the conference device;
wherein the conference device is further configured to:
generate a download link address corresponding to at least one of the conference record or the conference summary.

52. The conference system according to claim 44, wherein,
the conference device is configured to translate the voice text into a translated text corresponding to a preset language type; or,
the conference device is configured to translate the voice text into a translated text corresponding to a preset language type through a connected edge end device; or,
the server is configured to: translate the voice text into a translated text corresponding to a preset language type, and send the translated text to the conference device;
wherein the conference device is further configured to display the conference content related to the voice text through at least one of:
displaying the voice text in real time;
displaying a user name corresponding to the voice text in real time;
displaying a conference record related to the voice text;
displaying a conference summary related to the voice text;
displaying a translated text of a preset language type translated from the voice text in real time;
displaying a download link address corresponding to a conference record related to the voice text; or
displaying a download link address corresponding to a conference summary related to the voice text.
